(19) United States
(12) Patent Application Publication
(10) Pub. No.: US 2007/0205033 A1
(43) Pub. Date: Sep. 6, 2007

(54) Accelerator and brake assembly protection system

(75) Inventors: Donald S. Hanson, Evans, GA (US); Aric Singletary, Hephzibah, GA (US); Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/365,904

(22) Filed: Mar. 1, 2006

(51) Int. Cl. B62D 25/20

(52) U.S. Cl. 180/90.6

(57) ABSTRACT

A protection system for an accelerator and brake (A&B) assembly of a utility vehicle is provided. The protection system comprises a brake pedal (BP) protective boot that conforms with and sealingly fits around a brake pedal arm. The protection system additionally includes an accelerator pedal (AP) protective boot that conforms with and sealingly fits around an accelerator pedal arm.

### FIELD

The present disclosure relates to a protection system for an accelerator and brake assembly.

### BACKGROUND

The accelerator and brake pedal assembly of light weight utility vehicles, such as maintenance vehicles, shuttle vehicles and golf cars, are susceptible to interference, contamination and/or damage from objects, debris and/or liquids inadvertently gathering around the accelerator and/or brake pedals. More specifically, often liquids, small objects or debris will infiltrate accelerator and/or brake mechanisms located below the vehicle floorboard through openings in the floorboard for accelerator and brake pedal arms that connect the accelerator and brake mechanisms to respective accelerator and brake foot pads. Such infiltration can damage, foul, corrode and/or jam the accelerator and/or brake mechanisms causing hazardous operating conditions and/or increased maintenance costs. Additionally, objects and/or debris can inadvertently gather around the accelerator and/or brake pedal arms jamming or interfering with the operation of the pedals causing hazardous operating conditions.

### SUMMARY

In various embodiments, a protection system for an accelerator and brake (A&B) assembly of a utility vehicle is provided. The protection system comprises a brake pedal (BP) protective boot that conforms with and sealingly fits around a brake pedal arm. The protection system additionally includes an accelerator pedal (AP) protective boot that conforms with and sealingly fits around an accelerator pedal arm. The BP and AP protective boots protect against objects and/or debris interfering with the operation of the brake and accelerator pedals. Furthermore, the protective boots protect against liquids, objects and/or debris infiltrating the A&B assembly around the brake and accelerator pedal arms.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of a light-weight utility vehicle including a protection system for a accelerator and brake (A&B) assembly, in accordance with various embodiments of the present disclosure;

FIG. 2 is an isometric illustration of the A&B assembly shown in FIG. 1 mounted to a frame structure of a utility vehicle;

FIG. 3 is an isometric view of an accelerator pedal protective boot, a brake pedal protective boot and a mounting plate cover included in the protection system shown in FIG. 1, in accordance with various embodiments of the present disclosure;

FIG. 4 is an isometric view of accelerator and brake pedal protective boots and a floor mat included in the protection system shown in FIG. 1, in accordance with various embodiments of the present disclosure;

FIG. 5 is an isometric view of a brake pedal (BP) protective boot included in the A&B protection system shown in FIG. 1, in accordance with various implementations of the present disclosure;

FIG. 6 is an isometric view of an accelerator pedal (AP) protective boot included in the A&B protection system shown in FIG. 1, in accordance with various implementations of the present disclosure;

FIG. 7 is an isometric view of a mounting plate cover included in the A&B protection system shown in FIG. 1, in accordance with various implementations of the present disclosure;

FIG. 8 is a side cross-sectional view of the A&B protection system through the brake pedal protective boot, at line 7-7 of FIG. 6;

FIG. 9 is a side cross-sectional view of the A&B protection system through the accelerator pedal protective boot, at line 8-8 of FIG. 6;

FIG. 10 is a sectional top view of the brake pedal arm and a neck of the BP protective boot shown in FIG. 3, at line 10-10 of FIG. 8;

FIG. 11 is a cross-sectional view of the AP protective boot shown in FIG. 6 at line 11-11; and

FIG. 12 is an isometric view of the A&B assembly protection system shown in FIG. 1, in accordance with various embodiments of the present disclosure.

### DETAILED DESCRIPTION

The following description of various embodiments is merely exemplary in nature and is in no way intended to limit the present teachings, application, or uses.

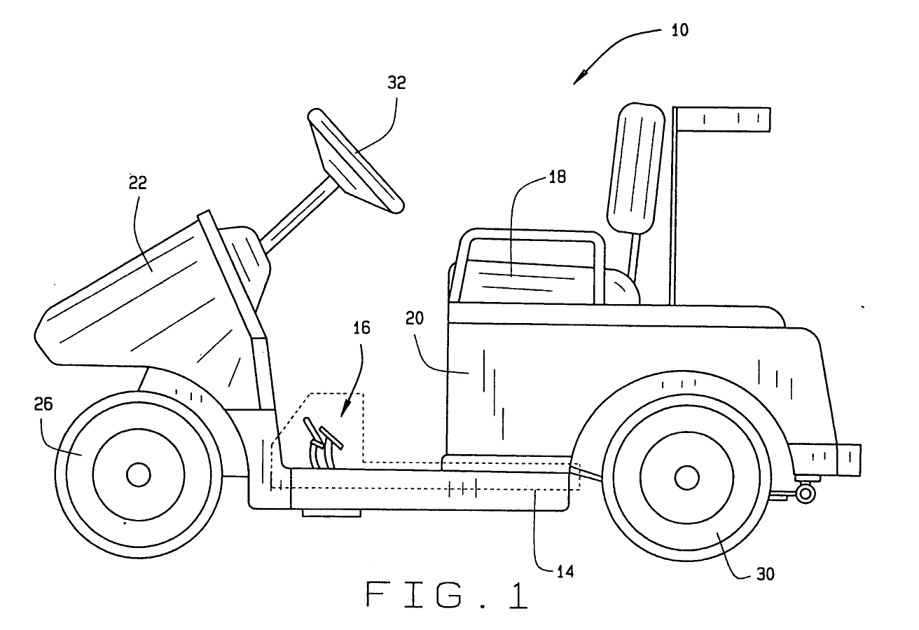

FIG. 1 illustrates a light-weight utility vehicle 10, such as a small cargo/maintenance vehicle, a shuttle vehicle or a golf car, that includes a protection system 14 for an accelerator and brake (A&B) assembly 16 of the vehicle 10. The vehicle 10 also generally includes a seat assembly 18 mounted to a rear body section 20, a front body section 22 and a pair of front wheels 26 that operate to steer the vehicle 10. Additionally, the vehicle 10 generally includes a pair of rear wheels 30, wherein at least one of the rear wheels 30 functions as a drive wheel for propelling vehicle 10 and a steering wheel 32 used to control a steering angle of the front wheels 26.

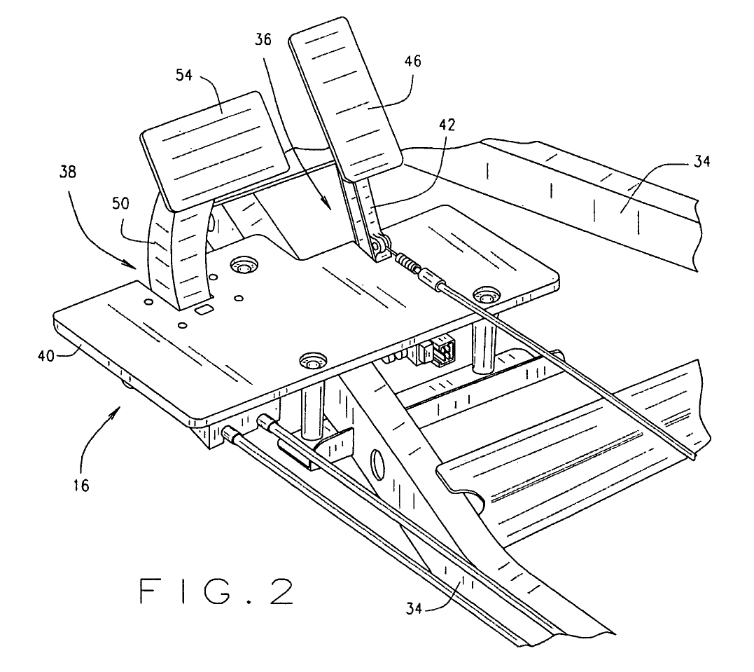

Referring to FIG. 2, the A&B assembly 16 can comprise a mounting plate 40 that is connected, e.g. bolted, to a frame structure 34 of the vehicle 10. The A&B assembly 16 can additionally include an accelerator pedal subassembly 36 and a brake pedal subassembly 38 operably mounted to accelerator and brake mounts (not shown) extending from an underside of the mounting plate 40. The accelerator pedal subassembly 36 generally comprises an accelerator pedal arm 42 and an accelerator pedal 46 coupled to the accelerator pedal arm 42. The brake pedal subassembly 38 generally comprises a brake pedal arm 50 and a brake pedal 54 coupled to the brake pedal arm 50.

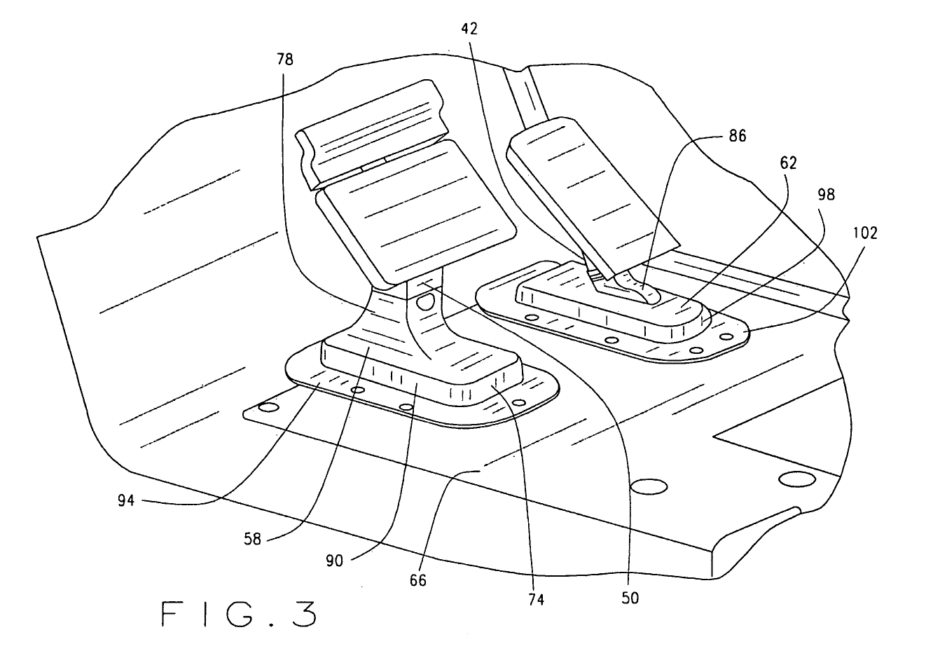

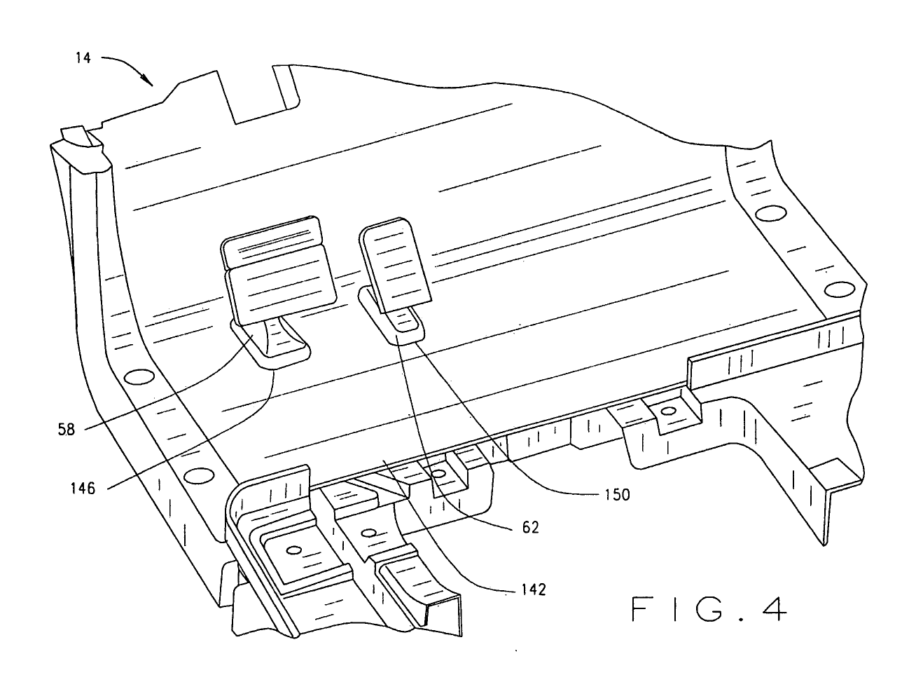

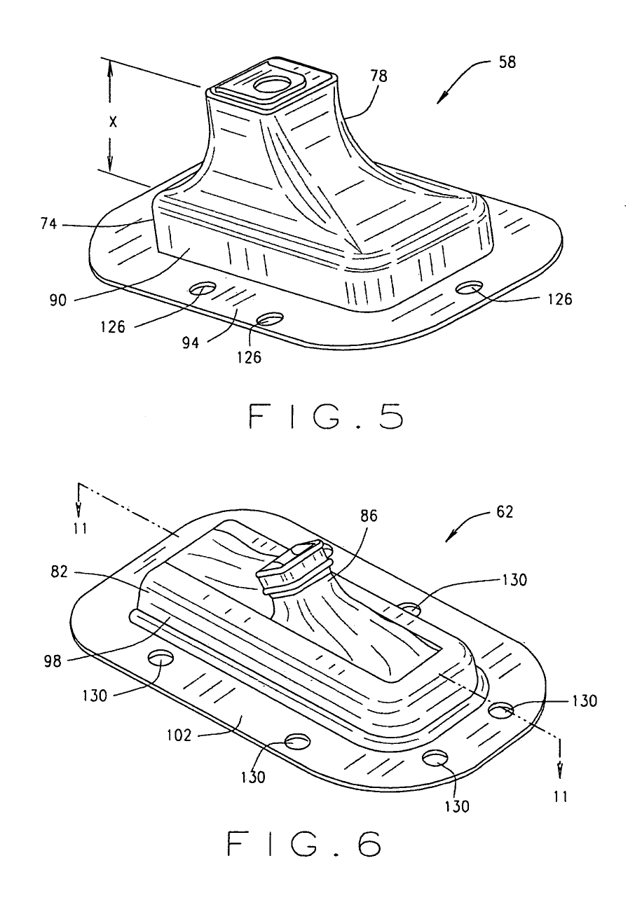

Referring to FIGS. 3 and 4, in various embodiments, the A&B protection system 14 can comprise a brake pedal (BP) protective boot 58 that sealingly fits around the brake pedal arm 50 and an accelerator pedal (AP) protective boot 62 that sealingly fits around the accelerator pedal arm 42. The A&B protection system 14 can additionally include mounting plate cover 66 covering the mounting plate 40 of the A&B assembly 16. Also referring now to FIGS. 5 and 6, the BP protective boot 58 comprises a base portion 74 and a neck portion 78, similarly the AP protective boot comprises a base portion 82 and a neck portion 86. The BP protective boot base portion 74 includes a body 90 and a lip 94, and the AP protection boot portion 82 includes a body 98 and a lip 102.

The BP boot neck portion 78 is adapted to sealingly fit around the brake pedal arm 50. That is, the BP boot neck portion 78 can be formed to conform or contour with, fit tightly around and substantially form a seal around the brake pedal arm 50. The seal effectively prevents liquids, objects and debris from infiltrating the seal. Similarly, the AP boot neck portion 86 can be formed to conform or contour with, fit tightly around and substantially form a seal around the accelerator pedal arm 42 to effectively prevent liquids, objects and debris from infiltrating the seal. In various embodiments, the BP and AP protective boots 58 and 62 are fabricated of any material suitably liquid resistant, flexible, resilient and durable, to form the seals around the brake and accelerator arms 50 and 42 and allow the brake and accelerator arms 50 and 42 to move through the entire respective ranges of motions without overstressing, cracking or tearing. For example, the BP and AP protective boots 58 and 62 can be fabricated from any suitable elastomer such as rubber or a synthetic polymer.

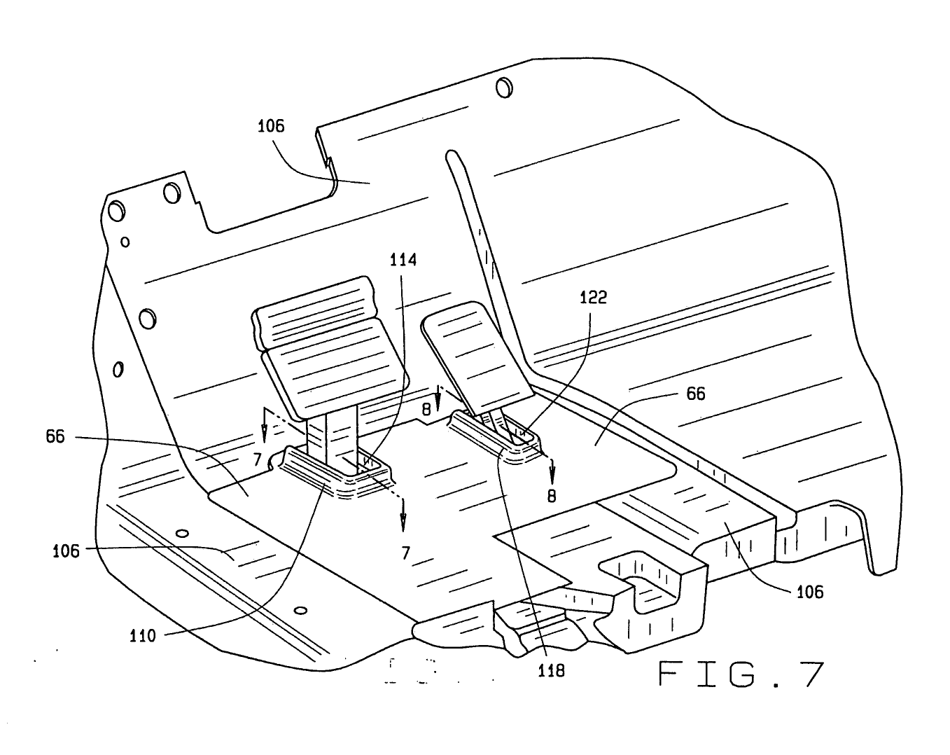

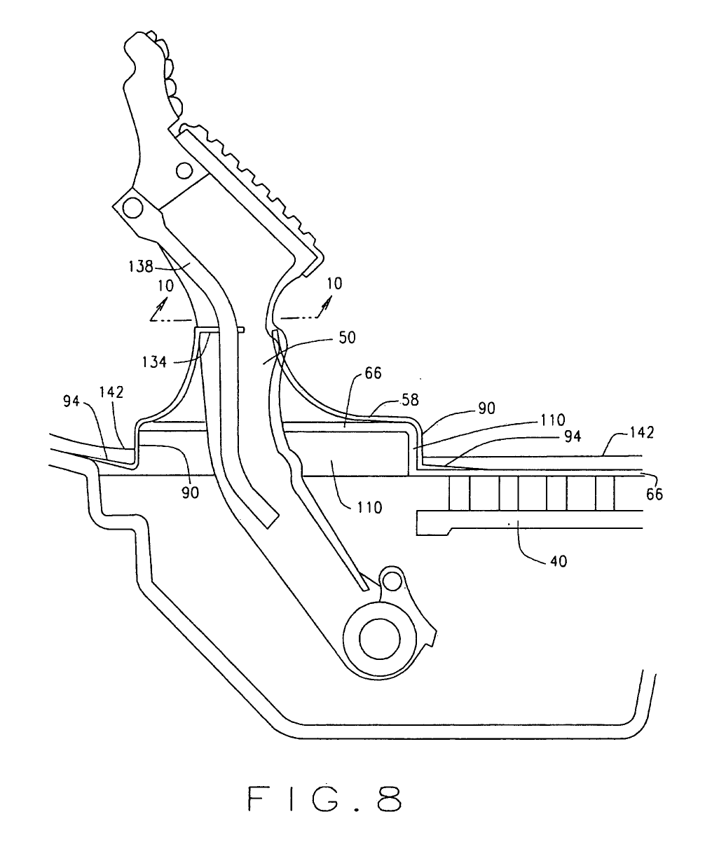

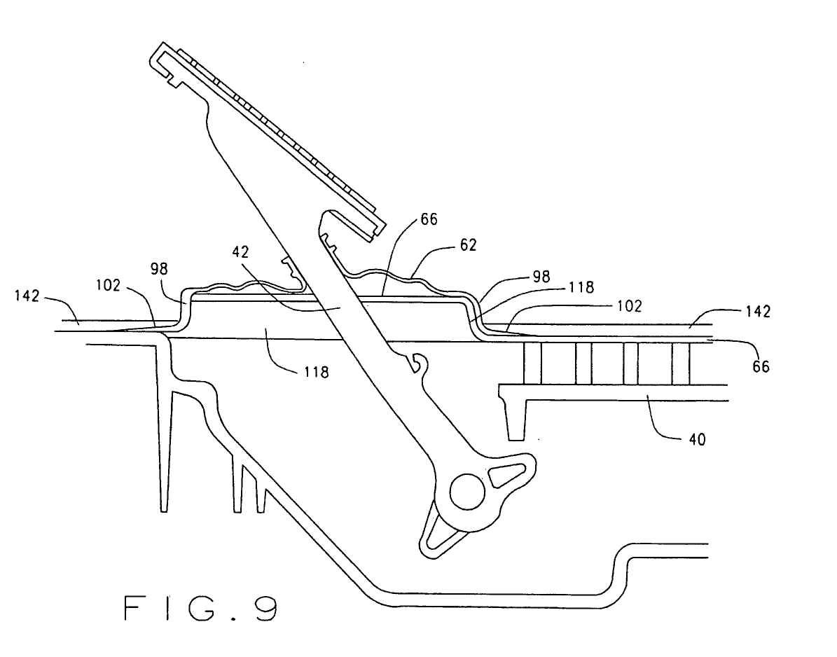

Referring to FIGS. 7, 8 and 9, in various embodiments the mounting plate cover 66 can be positioned around the brake and accelerator arms 50 and 42, and over the mounting plate 40 to provide a substantially smooth continuation of a floor structure 106 across the modular A&B assembly 16. The mounting plate cover 66 can include a raised wall 110 around a brake pedal opening 114 through which the brake pedal arm 50 extends and a raised wall 118 around a brake pedal opening 122 through which the accelerator pedal arm 42 extends. In various implementations, the BP protective boot base portion 74 is formed to fit over and substantially conform or contour with the mounting plate cover BP opening raised wall 110, and the AP protective boot base portion 82 is formed to fit over and substantially conform or contour with the mounting plate cover AP opening raised wall 118. More particularly, the BP base portion body 90 is formed to fit over and substantially conform or contour with the mounting plate cover BP opening raised wall 110, while the BP base portion lip 94 is utilized to couple the BP protective boot 58 to the mounting plate cover 66. Likewise, the AP base portion body 98 is formed to fit over and substantially conform or contour with the mounting plate cover BP opening raised wall 118, while the AP base portion lip 102 is utilized to couple the AP boot 62 to the mounting plate cover 66.

The BP and AP boots 58 and 62 can be coupled, connected or attached to the mounting plate cover 66 using any suitable fastening means, for example, glue, adhesive, staples, screws, rivets or push pins. In exemplary embodiments, the BP and AP boots 58 and 62 are coupled, connected or attached to the mounting plate cover 66 using push pins inserted through apertures 126 in the BP boot base portion lip 94 and apertures 130 in the AP boot base portion lip 102. When the BP and AP protective boots 58 and 62 are sealingly fitted around the respective BP and AP arms 50 and 42, and connected to the mounting plate cover 66, as described above, the BP and AP protective boots 58 and 62 effectively cover and seal the BP and AP openings 114 and 122. Thus, liquids, objects and debris are effectively prevented from infiltrating, blocking, or jamming the BP and AP openings 114 and 112. Therefore, the brake pedal and accelerator pedal can be safely and easily operated without interference, contamination and/or damage from objects, debris and/or liquids inadvertently gathering around the BP and AP arms 50 and 42 or fouling the BP and AP subassemblies 38 and 36.

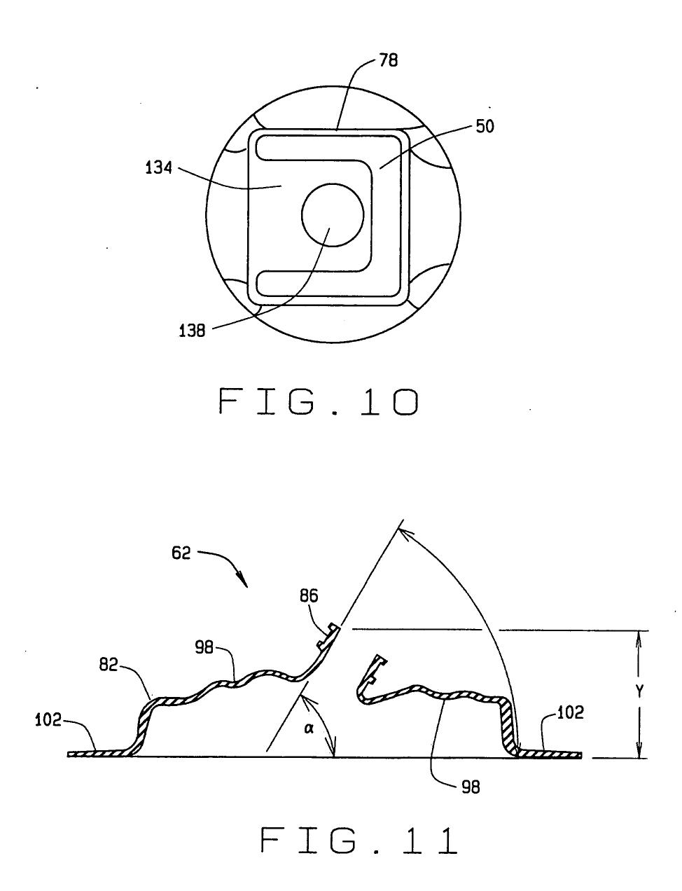

Referring now to FIGS. 5, 8 and 10, in various embodiments, the BP protective boot 58 can comprise a parking brake rod flap 134. The parking brake rod flap 134 is formed to fit around a parking brake rod 138 extending within a U-shaped brake pedal arm 50 that extends along the length of the brake pedal arm 50. The parking brake rod flap 134 effectively provides a seal within the U-shaped BP arm 50 to substantially prevent liquids, objects and debris from infiltrating or lodging between the parking brake rod 138 and the U-shaped BP arm 50. Furthermore, the parking brake rod flap 134 is connected to the BP boot neck portion 78 such that the parking brake rod flap will allow the parking brake rod 138 to linearly move within the U-shaped brake arm 50.

Additionally, in various embodiments, the BP protective boot 58 can be formed to have a low profile that adds durability and longevity to the BP protective boot 58. Particularly, the BP protective boot 58 has a height X that provides sufficient stability to the neck portion 78 while minimizing stress on the BP protective boot 58 throughout the range of motion of the BP arm 50, e.g., a range of motion of between approximately 30° to 40°. The height X is predetermined to be sufficiently tall such that the neck portion 78 will not easily collapse, sag or invert and will generally maintain the height X during operation of the of the brake pedal 38. Additionally, the height X is predetermined to be sufficiently short such that the BP protective boot 58 is not overstressed, causing cracking or tearing of the BP protective boot 58, during operation of the of the brake pedal subassembly 38. In various implementations the height X can be between and inclusive of approximately 62 mm (millimeters) and 66 mm, for example, between approximately 63.24 mm and 65.24 mm, e.g., approximately 64 mm.

Referring now to FIGS. 6, 9 and 11, in various embodiments, the AP protective boot 62 can be formed to have a low profile that adds durability and longevity to the AP protective boot 62. Additionally, the AP boot neck portion 86 is formed at an angle with respect to the base portion 82 that further adds durability and longevity to the AP protective boot 62. Particularly, the neck portion 86 is formed at an angle α suitable to allow the AP arm 42 to move through an entire travel range, i.e., range of motion, of the AP arm 42 without overstressing, cracking or tearing the AP protective boot 62, e.g., a travel range of between approximately 45° to 60°. In various implementations, the angle a can be between, and inclusive of, approximately 45° and 70°, for example between approximately 54° and 62°, e.g., approximately 57°. To further enhance the durability and longevity of the AP protective boot 62, the AP protective boot 62 is formed to have a height Y that provides sufficient stability to the neck portion 86, allows the AP arm 42 to move through its entire travel range, and minimizes stress on the BP protective boot 58 throughout the travel range of the AP arm 42. The height Y is predetermined to be sufficiently tall such that the neck portion 86 will not easily collapse, sag or invert and will generally maintain the height Y during operation of the accelerator pedal subassembly 36. Additionally, the height Y is predetermined to be sufficiently short such that the AP protective boot 58 is not overstressed, causing cracking or tearing of the AP protective boot 62, during operation of the accelerator pedal subassembly 36. In various implementations the height Y can be between and inclusive of approximately 40 mm and 48 mm, for example, between approximately 42 and 46 mm, e.g. approximately 43.9 mm.

Referring to FIGS. 4, 8 and 9 in various embodiments, the A&B assembly protection system 14 can further include a floor mat 142 positioned over the mounting plate cover 66 and around the BP and AP protective boots 58 and 62. The floor mat 142 can comprise a BP boot aperture 146 and an AP boot aperture 150 that fit around the BP and AP protective boots 58 and 62. Particularly, the BP boot aperture can be sized to closely match the perimeter of the BP boot base portion body 90 and overlay, or overlap, the BP boot base portion lip 94. Likewise, the AP boot aperture can be sized to closely match the perimeter of the AP boot base portion body 98 and overlay, or overlap, the AP boot base portion lip 102. Overlaying, or overlapping, the BP and AP boot base portion lips 94 and 102, the floor mat 142 adds another layer of protection against liquids, objects and/or debris from infiltrating, blocking, or jamming the BP and AP openings 114 and 112. Therefore, the brake pedal and accelerator pedal can be safely and easily operated without interference, contamination and/or damage from objects, debris and/or liquids inadvertently gathering around the BP and AP arms 50 and 42 or fouling the BP and AP subassemblies 38 and 36.

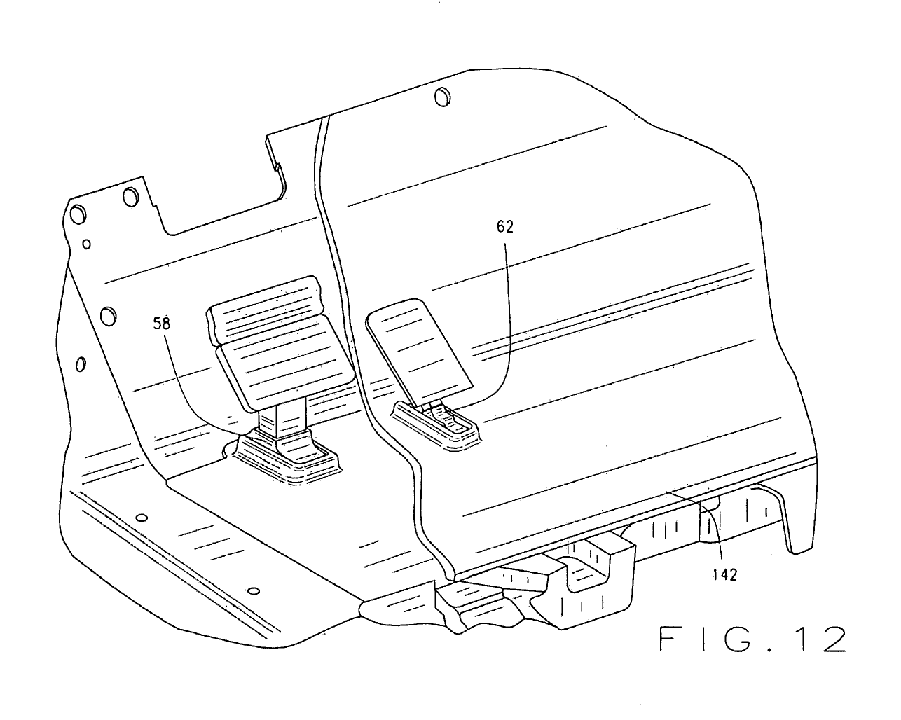

Referring now to FIGS. 2 and 12, in various implementations, the BP and AP protective boots 58 and 62 are attached to the mounting plate 14 such that the BP and AP protective boots 58 and 62 are located below and substantially concealed by the mounting plate cover 66. More specifically, the AP boot base portion lip 102 can be couple to a mounting plate 40 of the A&B assembly 16 such that the AP boot 62 is located below and substantially concealed by a mounting plate cover 66. And, the BP boot base portion lip 94 can be coupled to the mounting plate 40 such that the BP boot 58 is located below and substantially concealed by the mounting plate cover 66. The BP and AP boots 58 and 62 can be coupled, connected or attached to the mounting plate 40 using any suitable fastening means, for example, glue, adhesive, staples, screws, rivets or push pins. In exemplary embodiments, the BP and AP boots 58 and 62 are coupled, connected or attached to the mounting plate 40 using push pins inserted through the apertures 126 and 130 in the BP and AP boot base portion lips 94 and 102 (shown in FIGS. 5 and 6).

Furthermore, in various embodiments, the BP and AP protective boots 58 and 62 are formed to have substantially smooth outer surfaces, free from folds, creases and grooves that may collect liquids, dirt, dust, objects and/or debris.

Thus, the various embodiments of the A&B assembly protection system 14 protects against objects and/or debris from interfering with the operation of the A&B assembly 16. The A&B assembly protection system 14 protects against liquids, objects and/or debris from infiltrating the A&B assembly 16 around the brake and accelerator pedal arms and from collecting around the BP and AP arms 38 and 36. Therefore, the brake pedal and accelerator pedal can be safely and easily operated without interference, contamination and/or damage from objects, debris and/or liquids inadvertently gathering around the BP and AP arms 50 and 42 or fouling the BP and AP subassemblies 38 and 36.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A protection system for a light weight utility vehicle accelerator and brake (A&B) assembly, said system comprising a brake pedal (BP) protective boot sealingly fitted around a brake pedal arm of the brake (A&B) assembly and an accelerator pedal (AP) protective boot sealingly fitted around an accelerator pedal arm of the brake (A&B) assembly.

2. The system of claim 1, wherein the AP protective boot comprises a neck portion that sealingly fits around the accelerator pedal arm and the AP protective boot has a low height profile at the neck portion.

3. The system of claim 2, wherein the AP protective boot has a height of approximately 40 to 48 millimeters at the neck portion.

4. The system of claim 2, wherein the AP protective boot is adapted to allow the neck portion to move with the accelerator pedal arm though an entire travel range of the accelerator pedal arm.

5. The system of claim 2, wherein the AP protective boot is adapted to allow the neck portion to move with the accelerator pedal arm though a travel range of between approximately 45° and 60°.

6. The system of claim 1, wherein the AP boot comprises a base formed to fit over a raised wall around an accelerator pedal arm opening in a mounting plate cover covering the A&B assembly, the AP boot base adapted to couple to a mounting plate cover.

7. The system of claim 6, wherein the system further comprises a floor mat adapted to fit around the AP boot base and overlay a lip of the AP boot base.

8. The system of claim 1, wherein the BP boot comprises a base formed to fit over a raised wall around a brake pedal arm opening in a mounting plate cover covering the A&B assembly, the BP boot base adapted to couple to a mounting plate cover.

9. The system of claim 8, wherein the system further comprises a floor mat adapted to fit around the BP boot base and overlay a lip of the BP boot base.

10. The system of claim 1, wherein the AP boot comprises a base adapted to couple to a mounting plate of the A&B assembly such that the AP boot is located below and substantially concealed by a mounting plate cover; and the BP boot comprises a base adapted to couple to the mounting plate such that the BP boot is located below and substantially concealed by the mounting plate cover.

11. A protection system for a light weight utility vehicle accelerator and brake (A&B) assembly, said system comprising:
a brake pedal (BP) protective boot sealingly fitted around a brake pedal arm of the brake (A&B) assembly;
an accelerator pedal (AP) protective boot sealingly fitted around an accelerator pedal arm of the brake (A&B) assembly; and
a mounting plate cover covering a mounting plate of the A&B assembly, the mounting plate cover comprising a raised wall around a brake pedal arm opening and a raised wall around an accelerator pedal arm opening.

12. The system of claim 11, wherein the AP protective boot comprises a neck portion that sealingly fits around the accelerator pedal arm.

13. The system of claim 12, wherein the AP protective boot has a height of approximately 40 to 48 millimeters at the neck portion and is adapted to allow the neck portion to move with the accelerator pedal arm though an entire travel range of the accelerator pedal arm of approximately 45° to 60°.

14. The system of claim 11, wherein the AP boot comprises a base portion comprising a body formed to fit over and substantially conform with the raised wall around the accelerator pedal arm opening, and a lip for coupling the AP boot to the mounting plate cover.

15. The system of claim 14, wherein the BP boot comprises a base portion comprising a body formed to fit over and substantially conform with the raised wall around the brake pedal arm opening, and a lip for coupling the BP boot to the mounting plate cover.

16. The system of claim 15, wherein the system further comprises a floor mat adapted to fit around the AP boot base portion body and overlay the lip of the AP boot base portion and to fit around the BP boot base portion body and overlay the lip of the BP boot base portion.

17. The system of claim 11, wherein the AP boot and the BP boot each comprise a base portion adapted to couple to the mounting plate such that the AP and BP boots are located below and substantially concealed by the mounting plate cover.

18. A light weight utility vehicle comprising:
an accelerator and brake (A&B) assembly for controlling movement of the utility vehicle; and
a protection system for protecting the A&B assembly, the protection system comprising:
a mounting plate cover covering a mounting plate of the A&B assembly, the mounting plate cover comprising a raised wall around a brake pedal arm opening and a raised wall around an accelerator pedal arm opening;
a brake pedal (BP) protective boot comprising a neck portion and a base portion, the neck portion sealingly fitting around a brake pedal arm, the base portion comprising a body that fits over and substantially conforms with the raised wall around the brake arm opening and a lip for coupling the BP boot to the mounting plate cover; and
an accelerator pedal (AP) protective boot comprising a neck portion and a base portion, the neck portion sealingly fitting around an accelerator pedal arm, the base portion comprising a body that fits over and substantially conforms with the raised wall around the accelerator arm opening a lip for coupling the AP boot to the mounting plate cover.

19. The vehicle of claim 18, wherein the AP protective boot has a height of approximately 40 to 48 millimeters at the neck portion and is adapted to allow the neck portion to move with the accelerator pedal arm though an entire travel range of the accelerator pedal arm of approximately 45° to 60°.

20. The vehicle of claim 18, wherein the protection system further comprises a floor mat adapted to fit around the AP boot base portion body and overlay the lip of the AP boot base portion and to fit around the BP boot base portion body and overlay the lip of the BP boot base portion.
